(19) United States
(12) Patent Application Publication
(10) Pub. No.: US 2007/0294260 A1
(43) Pub. Date: Dec. 20, 2007

(54) Software emulation tutorials

(76) Inventors: Tom Lam, Chula Vista, CA (US); Don Nguyen, San Marcos, CA (US); Kenneth Lee, Murietta, CA (US); Guoxuan Zhang, San Diego, CA (US)

Correspondence Address: MAYER & WILLIAMS PC, 251 NORTH AVE. WEST, 2ND FLOOR, WESTFIELD, NJ, 07090, US

(21) Appl. No.: 11/701,925

(22) Filed: Feb. 2, 2007

Related U.S. Application Data
(60) Provisional application No. 60/814,218, filed on Jun. 16, 2006.

(51) Int. Cl. G06F 17/30

(52) U.S. Cl. 707/10; 707/E17.008

(57) ABSTRACT

A method and arrangement is provided for creating a tutorial for troubleshooting a software application. The method begins by saving captured display screens of a software application operating on the respective versions of the hardware device in one or more files. This step is repeated for each of a plurality of different versions of a hardware device. Next, each of the files for the plurality of different versions of the hardware device is distributed so that they are accessible to a plurality of help centers. In this way customer support can be provided to users of any of the plurality of different versions of the hardware device.

### STATEMENT OF RELATED APPLICATION

This application claims the benefit of U.S. Provisional Patent Application Ser. No. 60/814,218, filed Jun. 16, 2006, entitled “Tutorials Emulation System,” the entire disclosure of which is incorporated by reference herein.

### FIELD OF THE INVENTION

The present invention relates generally to help centers made available by computer hardware providers, and more particularly to a tutorial to be used by call agents at the help centers to assist customers with application software operating on computer hardware supplied by the hardware provider.

### BACKGROUND OF THE INVENTION

Providers of electronic hardware devices such as general purpose computers (e.g., PCs) include manufacturers, assemblers, vendors and the like. Such hardware providers are continually launching new product offering including updated versions of existing product lines as well as entirely new hardware platforms. For example, a manufacturer such as Sony may offer several different series of PCs each with several or more different models.

The rapid expansion of the computer industry and the resulting wide diversity of products offered by hardware providers place great demands on the support services they provide to their customers. To meet these demands hardware providers often make available one or more staffed help centers with which users can communicate by phone or electronic mail. The help center personnel must continually keep up with the new products that are made available after each development cycle. This task is made even more complex because of the wide variety of software products that are available to operate on the hardware devices. Moreover, software development cycles often proceed at an even greater pace than hardware development cycles. Even when a software product is simply an upgrade of an existing product, every addition, subtraction, or modification of the software can have a significant effect on its ability to properly operate on any given hardware platform. Because such software products need to be compatible with a wide variety of continually changing hardware systems and platforms, as well as other software products, there is a great need for extensive customer service available from the help centers.

The help centers of hardware providers are often widely distributed over multiple locations across one or more countries or even the entire world. The help centers may collectively have upwards of several hundred or more personnel that must be familiar with the product offerings in order to assist consumers. To keep up with product updates new hardware releases are often physically delivered to the help centers so that personnel can familiarize themselves with the products. Likewise, new application software releases are also delivered to the help centers so that the personnel can familiarize themselves with their operation on the new hardware releases. This process, in addition to being very costly and time-consuming, makes it difficult to assist customers in a timely manner and to provide them with satisfactory information sufficient to troubleshoot or otherwise resolve their problem or problems.

### SUMMARY OF THE INVENTION

In accordance with the present invention, a method and arrangement is provided for creating a tutorial for troubleshooting a software application. The method begins by saving captured display screens of a software application operating on the respective versions of the hardware device in one or more files. This step is repeated for each of a plurality of different versions of a hardware device. Next, each of the files for the plurality of different versions of the hardware device is distributed so that they are accessible to a plurality of help centers. In this way customer support can be provided to users of any of the plurality of different versions of the hardware device.

In accordance with one embodiment of the invention, each of the files are distributed over a communications network.

In accordance with another embodiment of the invention, each of the files is physically distributed on an electronic storage medium to the help centers.

In accordance with another embodiment of the invention, the screen capturing and the distributing steps are repeated for each of a plurality of software applications bundled with the different versions of the hardware device.

In accordance with another embodiment of the invention, at least one computer-readable medium encoded with instructions which, when executed by a processor, performs a method that includes the following steps: receiving a selection of a given version of a hardware device selected from among a plurality of different versions of the hardware device; receiving a selection of a given software application selected from among a plurality of different software applications that reside on the selected hardware device; accessing one or more files that include a plurality of screenshots of the given application operating on the selected version of the hardware device; and displaying at least one of the screenshots.

In accordance with another embodiment of the invention, a graphical user interface is displayed that presents a first menu from which the given version of a hardware device can be selected from among the plurality of different versions of the hardware device.

In accordance with another embodiment of the invention, the graphical user interface further presents a second menu from which the given software application can be selected.

In accordance with another embodiment of the invention, the files further include annotations associated with the screen shots, said annotations including additional information concerning the screen shots.

In accordance with another embodiment of the invention, each of the annotations is displayed with the screen shot associated therewith.

In accordance with another embodiment of the invention, the files are accessed from an SQL database.

In accordance with another embodiment of the invention, the selections are received at a help center providing customer support to users of the hardware device.

In accordance with another embodiment of the invention, the selections are received from users of the hardware device.

In accordance with another embodiment of the invention, different portions of the files are distributed among different servers physically remote from one another.

In accordance with another embodiment of the invention, at least one of the servers is located at the help center.

### BRIEF DESCRIPTION OF THE DRAWINGS

FIG. 1 shows a schematic diagram of one example of a distributed help center in accordance with the present invention.

FIGS. 2 and 3 show an illustrative graphical user interface (GUI) provided by the front end interface program which enables a call agent to access the appropriate agent tutorial file or file.

FIG. 4 shows the GUI that appears after the hardware model and application software have been selected.

FIG. 5 is a flowchart showing one example of how a help agent uses the agent tutorial files to assist a user.

### DETAILED DESCRIPTION

Before detailing various embodiments of the invention, it may be helpful to present one illustrative environment in which the invention may be employed. Since an aspect of the present invention is directed to help centers that provide customer support for hardware devices and platforms on which various application software products operate, an understanding may be helpful of how some such help centers are currently arranged. It should be noted that the terms help center, call center, and support center, as well as other terms involving these words, are used interchangeably throughout this disclosure. The hardware devices and platforms referred to herein include general purpose computers as well as other electronic devices on which application software resides, such as mobile phones, personal digital assistants, servers, peripherals, digital cameras, and the like. The application software products referred to herein include operating systems (for example, DOS, Windows™, Windows™ 95, Windows™ 98, Windows™ 2000, Windows™ NT, Windows™ Millennium Edition, Windows™ XP, OS/2, or Linux), authoring applications (for example, word processing programs, database programs, spreadsheet programs, presentation programs, or graphics programs) capable of generating documents or other electronic content; client applications (for example, AOL user, CompuServe user, AIM user, AOL TV user, or ISP user) capable of communicating with other computer users, accessing various computer resources, and viewing, creating, or otherwise manipulating electronic content; and browser applications (for example, Netscape's Navigator or Microsoft's Internet Explorer) capable of rendering standard Internet content.

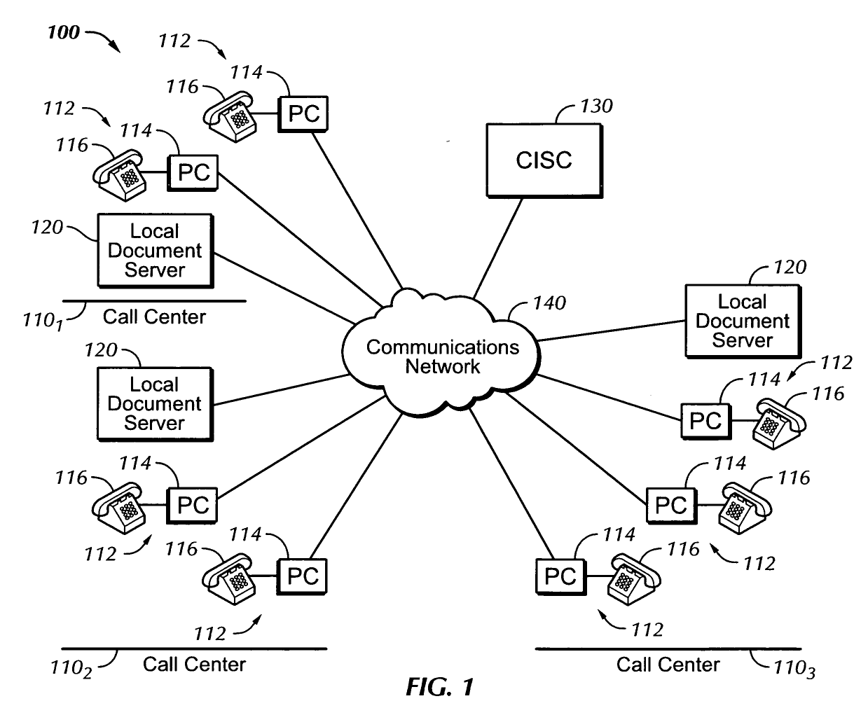

FIG. 1 shows a schematic diagram of one example of a distributed help center that may be used by a hardware or software provider to provide customer support for any of a variety of different hardware devices of the aforementioned type. The distributed help center 100 includes one or more call centers 110, three of which (help centers 110₁, 110₂ and 110₃) are shown for purposes of illustration. Each call center includes one or more help agents, who are represented by help agent stations 112 that include in this example a computer system 114 and a telephone 116. Each call center may also include one or more local document servers 120 on which various documentation may be made available to the call agents. In some cases some or all of the documentation may reside on the individual agents' computer systems 114, thereby possibly eliminating the need for the dedicated document server 120.

As previously noted, the help centers 110 shown in FIG. 1 in some cases may be distributed over large geographic regions (e.g., world-wide). Coordination among the various help centers may be achieved by providing a centralized location 130 that serves as a headquarters for all technical support. This location will be referred to herein as the customer information service center (CISC) 130. The CISC 130 may be in communication with the call centers 110₁, 110₂ and 110₃ over a communications network 140 such as the Internet, a private network, or the like. The CISC 130 may also be in communication with the local document servers 120 so that the CISC 130 can provide the call centers with any necessary documentation concerning the hardware and software to be supported.

As previously mentioned, to keep up with product updates new hardware and software releases are often physically delivered to the help centers so that personnel can familiarize themselves with the products. Constantly allocating and delivering new hardware and software products to the call centers 120 is a time-consuming and costly process. Moreover, the individual call agents must share the limited number of products that are provided for their familization, limiting the efficiency and effectiveness of the call agents.

To overcome the aforementioned problems and limitations, one aspect of the present invention is to create an agent tutorial file for many or all of the application software products that are pre-loaded onto or otherwise made available to consumers with the hardware device they received from the hardware provider. That is, for any given application software product, the present invention provides a separate agent tutorial file for each and every version (e.g., series and model) of the hardware product on which the given software product may reside. The different agent tutorial files for any particular software product will assist the agents in providing customer support that is tailored to the particular hardware device used by the consumer. This will allow the agents to assist consumers with problems that may arise with application software operating on different versions of a hardware device.

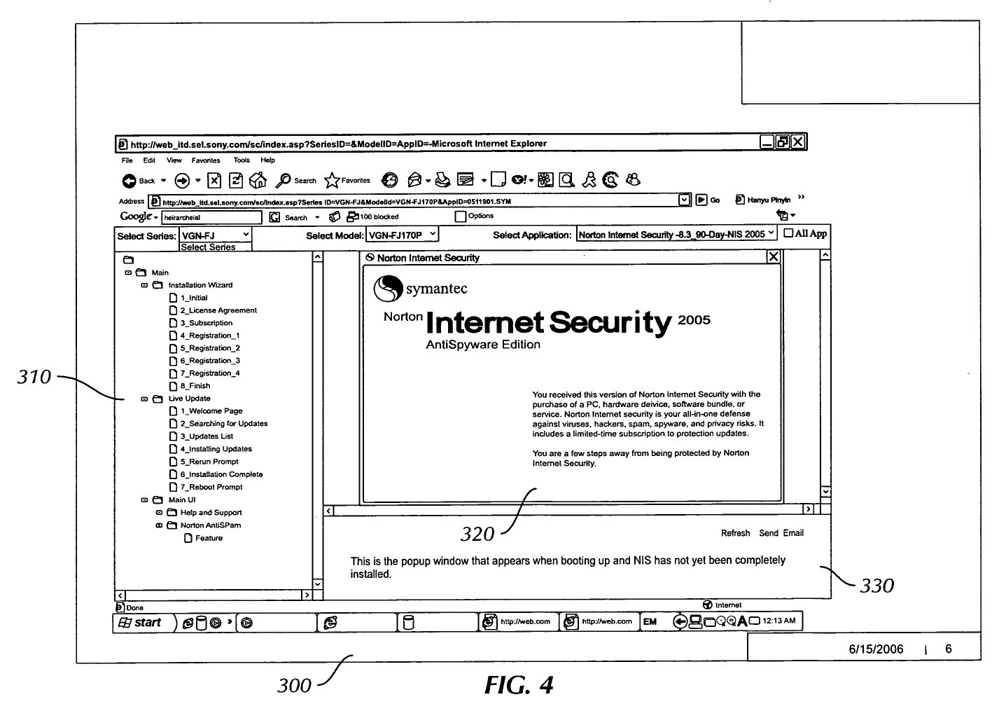

The agent tutorial files will generally include an assembly of captured screenshots that represent a given application software product operating on a particular hardware device. The screenshots can be obtained using a program that captures the screenshots as a user proceeds though execution of the application in a methodical and generally sequential order to ensure that most or all of the screens available in the application have been opened so that they can be captured. Such screen capturing software is commercially available and is disclosed, for example, in U.S. Appl. Serial No. 2006/0073462. In addition to capturing screen shots, any additionally available information may also be optionally recorded such as curser positions and keystrokes, for example. The user may also annotate the screen shots with notes that may be helpful to the call agents when assisting a customer. The annotations allow for the addition of many types of aids that can further enhance the usefulness of the tutorial files. The annotations may be added so that they are displayed in conjunction with or over the screenshots. Alternatively, the annotations may be in the form of compressed audio segments that are associated with the screenshots. In general, the annotations may include additional information (or links thereto) about the displayed screen shot such as known problems, hidden option, trigger points and the like. In addition, as shown in FIG. 4, an icon may be provided that allows the call agent to send an email concerning the screen to an appropriate individual with more expertise in the operation of the software application on the particular hardware device.

The agent tutorial files may be cataloged in an Structured Query Language (SQL) database. The use of an SQL database allows the name, vendor and version of the application software products to be readily tracked. With this information, a unique identification number can be associated with each application software product.

Once the agent tutorial files are prepared they can be loaded onto a server (e.g., an SQL server) located at the CISC 130. The CISC 130, in turn, can then upload the files to each help center, either to the local document server 120 or directly to the individual computer systems associated with the help agent stations. While less preferred because of the delays imposed, the agent tutorial files alternatively may be stored on an electronic or optical medium (e.g., hard drive, CD) and physically distributed to each of the help centers.

In some embodiments of the invention various portions of the agent tutorial files may be distributed among different locations and/or servers for access by the call agents. For example, images (e.g., the screenshots) may locally reside at each of the call centers while any additional information or other data associated with the screenshots may be maintained at the CISC. Agents at the call centers can access this additional information as needed.

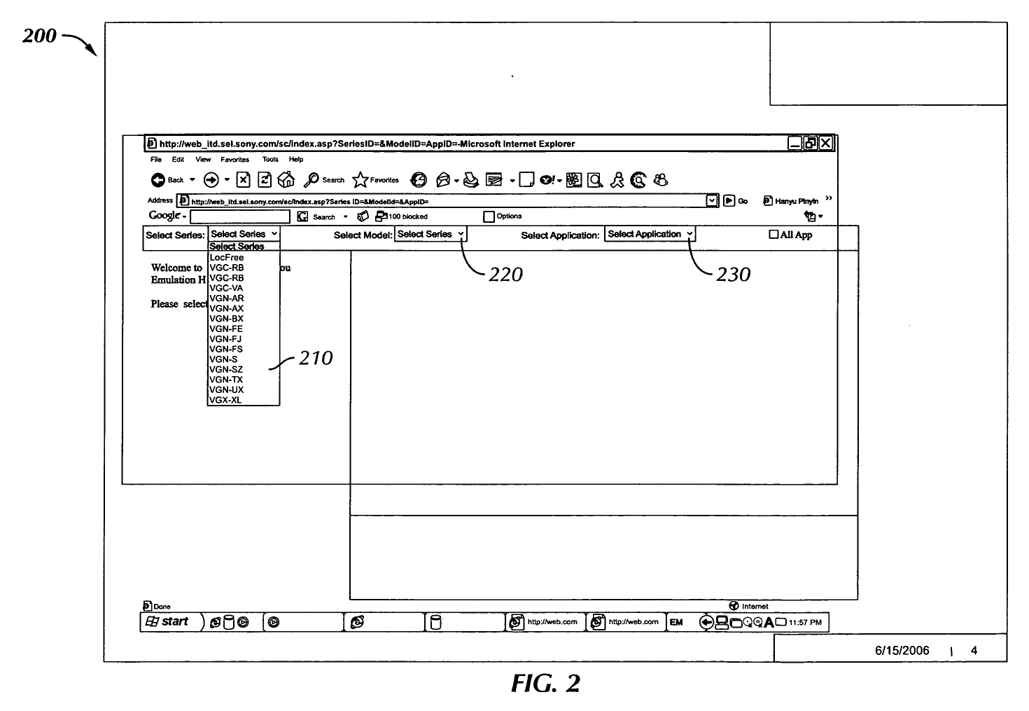

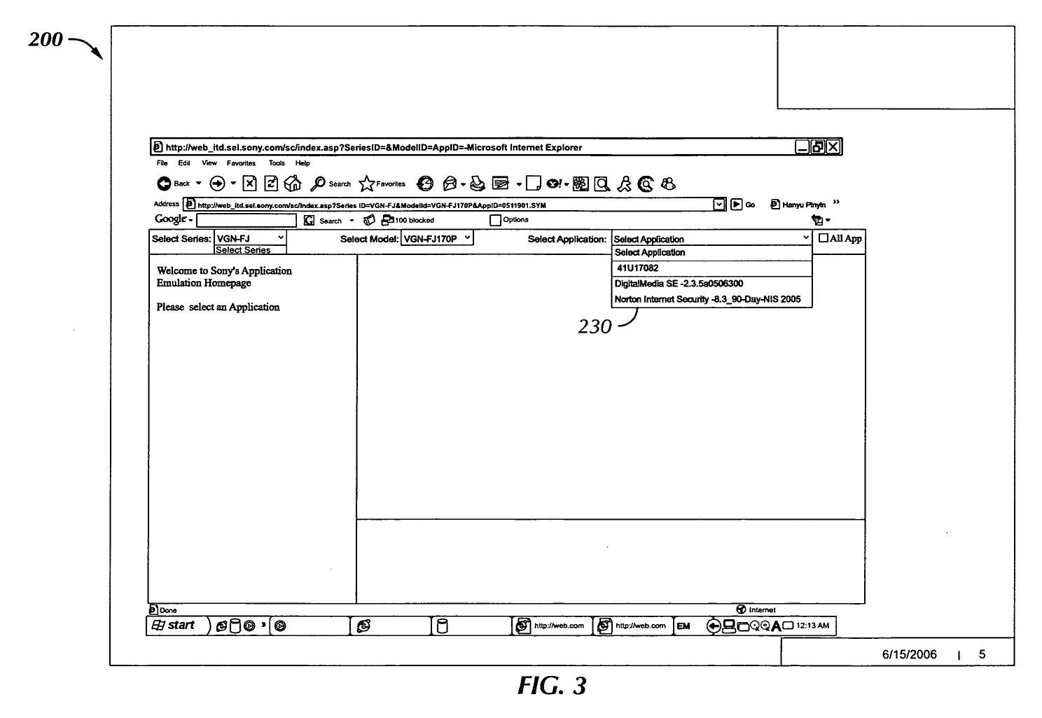

At the help centers, the help agents use a front end interface program located on their computer stations to access and use the agent tutorial files. FIG. 2 shows an illustrative graphical user interface (GUI) 200 provided by the front end interface program which enables a call agent to access the appropriate agent tutorial file or files, either upon receiving a call from a customer or in preparation for handling customer calls. In this example the GUI 200 is configured as a web browser. However, the GUI may be configured and arranged in any other appropriate manner as well. As shown in FIG. 2, the GUI 200 includes one or more drop-down menus that allow the call agent to select the appropriate series and model of the hardware device on which the application software is to operate. For instance, drop down menu 210 allows the agent to select the hardware series and the drop-down menu 220 allows the agent to select a particular hardware model within a selected series. As shown in both FIGS. 2 and 3, the GUI 200 also includes a drop-down menu 230 to select from among the available application software products that may be installed on the selected hardware model and for which an agent tutorial file is available. In some cases the drop-down menu 230 may also provide the agent with a list of all the applications installed on the selected hardware model regardless of whether or not agent tutorial files are available for that application and hardware model.

FIG. 4 shows the GUI 300 that appears after the hardware model and application software have been selected. In this example the application software that is selected is Norton™ Internet Security available from Symantec. As shown, a hierarchical outline of all the available screen shots is presented in an outline area 310 of the GUI 300. Upon selecting (using, for example, a mouse cursor) a screen shot of the application from the outline area 310, the screen shot becomes visible in a display area 320 of the GUI 300. In some cases the screen shot can be expanded to fill the screen by clicking on it. Also shown in FIG. 4 is the annotation area 330 of the GUI 300 in which notes or other annotations may be provided which are pertinent to the particular screen shot that is visible.

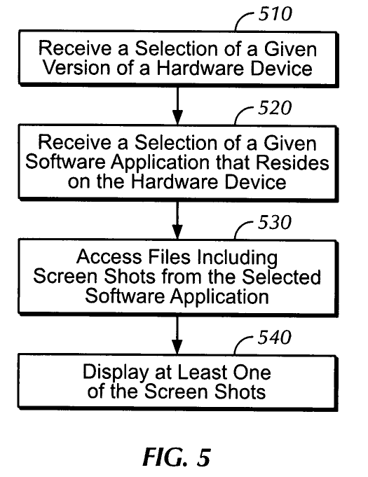

FIG. 5 is a flowchart showing one example of how a help agent uses the agent tutorial files to assist a user. The method begins at step 510 when the front-end interface receives from the help agent a selection of a given version of a hardware device selected from among a plurality of different versions of the hardware device. Next, in step 520 the front-end interface receives from the help agent a selection of a given software application. The given software application is selected from among a plurality of different software applications that reside on the selected hardware device. In response to received selections, one or more files are accessed in step 530. The files include a plurality of screenshots of the given application operating on the selected version of the hardware device. Finally, in step 540 at least one of the screenshots is displayed to the help agent so that the help agent can assist the user who initiates the query process.

As described above, the present invention offers a standardized customer support architecture for creating tutorials that can assistant call agents and their customers in addressing hardware and software problems. In addition, the support architecture can be easily distributed to help centers wherever they may be located. Since various portions of the tutorials may be locally or remotely available, the invention is readily adaptable to the different bandwidths that may available at the various call centers. Moreover, the present invention leverages the GUIs incorporated in the applications residing on the hardware devices to create simulations of the applications that can be used for tutorial and troubleshooting purposes.

In addition to the previously described results achieved by the present invention, the present invention also achieves a number of benefits and advantages which accrue from these results. For example, the amount of hardware and software that needs to be available and physically transported among the call centers is greatly reduced. Call center personnel do not have to spend time setting up equipment and physical space does not have to be allocated for the storage of the hardware products. Also, significant cost reductions can be achieved because the call agents have quick and easy access to system setups, troubleshooting information, and software applications. The call agents' enhanced access to this information can reduce the time between when a customer places a call and the time when the problem is resolved, thereby improving customer satisfaction. The tutorials can even be integrated into knowledge base solutions that are often available to agents and customers alike. Moreover, the same tutorials that are created and delivered to call agents can be provided to the customer's along with the hardware at the time of purchase or at a later time, thereby reducing the demand placed on the call centers. The tutorials can also better assist customers in discovering and using features of installed software that were unaware of or did not know how to effectively use.

1. A method of creating a tutorial for troubleshooting a software application, comprising:
for each of a plurality of different versions of a hardware device, saving captured display screens of a software application operating on the respective versions of the hardware device in one or more files; and
distributing each of the files for the plurality of different versions of the hardware device so that they are accessible to a plurality of help centers that provide customer support to users of any of the plurality of different versions of the hardware device.

2. The method of claim 1 wherein each of the files are distributed over a communications network.

3. The method of claim 1 wherein each of the files is physically distributed on an electronic storage medium to the help centers.

4. The method of claim 1 further comprising repeating the screen capturing and the distributing steps for each of a plurality of software applications bundled with the different versions of the hardware device.

5. The method of claim 1 wherein the software application is selected from the group consisting of operating systems, authoring applications, client applications and browser applications.

6. The method of claim 1 wherein the files are stored in an SQL database.

7. The method of claim 1 wherein the hardware device is a personal computer.

8. At least one computer-readable medium encoded with instructions which, when executed by a processor, performs a method including:
receiving a selection of a given version of a hardware device selected from among a plurality of different versions of the hardware device;
receiving a selection of a given software application selected from among a plurality of different software applications that reside on the selected hardware device;
accessing one or more files that include a plurality of screenshots of the given application operating on the selected version of the hardware device; and
displaying at least one of the screenshots.

9. The computer-readable medium of claim 8 further comprising displaying a graphical user interface that presents a first menu from which the given version of a hardware device can be selected from among the plurality of different versions of the hardware device.

10. The computer-readable medium of claim 9 wherein the graphical user interface further presents a second menu from which the given software application can be selected.

11. The computer-readable medium of claim 10 wherein the graphical user interface is configured as a web browser.

12. The computer-readable medium of claim 8 wherein the files are accessed over a communications network.

13. The computer-readable medium of claim 8 wherein the files further include annotations associated with the screen shots, said annotations including additional information concerning the screen shots.

14. The computer-readable medium of claim 13 wherein each of the annotations is displayed with the screen shot associated therewith.

15. The computer-readable medium of claim 8 wherein the files are accessed from an SQL database.

16. The computer-readable medium of claim 8 wherein the selections are received at a help center providing customer support to users of the hardware device.

17. The computer-readable medium of claim 16 wherein the selections are received from users of the hardware device.

18. The computer-readable medium of claim 8 wherein different portions of the files are distributed among different servers physically remote from one another.

19. The computer-readable medium of claim 17 wherein different portions of the files are distributed among different servers physically remote from one another.

20. The computer-readable medium of claim 19 wherein at least one of the servers is located at the help center.
